(19) United States
(12) Patent Application Publication
(10) Pub. No.: US 2010/0159266 A1
(43) Pub. Date: Jun. 24, 2010

(54) Clad can body stock

(76) Inventors: Karam Singh Kang, Kingston (CA); Paul Anthony Wycliffe, Amherstview (CA); Jeffrey Edward Geho, Aurora, IL (US)

Correspondence Address: Christopher C. Dunham;c/o Cooper & Dunham LLP, 30 Rockefeller Plaza, 20th Floor, New York, NY, 10112, US

(21) Appl. No.: 12/653,934

(22) Filed: Dec. 17, 2009

Related U.S. Application Data
(60) Provisional application No. 61/203,680, filed on Dec. 23, 2008.

(51) Int. Cl. B32B 1/08; B32B 15/01; B21D 43/28

(52) U.S. Cl. 428/586; 72/324

(57) ABSTRACT

The invention relates to can body stock having opposed surfaces. The can body stock has a core layer, a cladding layer at a first surface (intended to form an exterior surface of an eventual container body), and optionally a cladding layer at a second surface (intended to form an interior surface of an eventual container body). The cladding layer at the first surface is made of alloy AA3104 or AA3004 (or a modified version of AA3004 or AA3104 containing more iron and optionally more silicon), and the core layer is an aluminum alloy having yield strength less than that of the aluminum alloy of the cladding layer at the first surface. The can body stock may be used to produce a container body by a method involving drawing and ironing, as well as die necking to reduce the diameter of the open end of the container body.

### CROSS-REFERENCE TO RELATED APPLICATION

This application claims the priority right of co-pending U.S. provisional patent application Ser. No. 61/203,680 filed Dec. 23, 2008 by applicants named herein. The entire contents of application Ser. No. 61/203,680 are incorporated herein by reference.

### BACKGROUND OF THE INVENTION

(1) Field of the Invention

This invention relates to can body stock, i.e. metal sheet used for the production of bodies of beverage cans and similar metal containers. More particularly, the invention relates to can body stock made of alloys of aluminum.

(2) Description of the Related Art

Beverage can and similar container bodies are frequently made from an aluminum alloy that is rolled to form a sheet having a desired thickness. The rolled sheet is referred to as can body stock (CBS). The sheet is cut into blanks, cupped, extended by drawing and ironing, trimmed, and then shaped by a number of die necking operations before being closed at the open end by the attachment of an end closure, e.g. a can end wall often provided with a ring-pull opener, an atomizer device (e.g. for aerosol containers) or a screw cap (for so-called metal bottles that simulate glass bottles in shape).

Increasingly, such containers (especially metal bottles) are being provided with narrow ends that require many die necking operations to produce. Each operation involves pushing the open end of the container body into a shaped die to cause a progressive reduction in the diameter of the container body at the open end. The reduction of diameter achieved by each so-called necking-in step must be kept small because the metal will buckle, wrinkle or fracture if a reduction of diameter that is too large is attempted. Even so, such wrinkling of fracture may occur at one or more stages of the necking operation.

It is believed that, during a necking step (or any compressive action) carried out on work-hardened alloy used for can body stock, the longitudinal metal grains (shaped during sheet rolling) experience slippage at the free surface and at the die surface. This produces surface roughness, and the growth of such roughness (the increase of average peak to valley height, R_{z}) is linearly proportional to the total reduction at the open end of the container body. Therefore, the roughness grows as the number of necking-in steps increases or the degree of reduction of each step is increased. The growth of inside free surface roughness is almost twice that of the outer die-bound surface, and this can lead to wrinkling or fracture of the metal.

It has been found that specific aluminum alloys are required in practice for the production of metal container bodies because only such alloys can be used advantageously in the drawing and ironing step. These are alloys AA3004 and AA3104. However, such alloys do not have the best properties to resist wrinkling and fracture during die necking steps. It is therefore difficult to provide a metal for can body stock that is appropriate for all of the fabrication steps.

Various clad metal sheets are known for various purposes. For example, U.S. Pat. No. 7,255,932 issued to Raymond J. Kilmer on Aug. 14, 2007 discloses a multiple layer aluminum sheet, but this is intended as a brazing sheet designed to be attached to articles by brazing. The sheet consists of a core, a braze cladding and an interliner that provides corrosion resistance. The core may be an AA3000 series alloy that is bonded to a silicon-containing AA4000 braze alloy via the interliner. It is stated that an opposite side of the core may be bonded to an AA1000, 3000, 5000, 6000 or 7000 series layer either directly or via an interliner.

U.S. Pat. No. 4,141,482 issued to William G. Reynolds on Feb. 27, 1979 relates to compacted particle sheets wrought from scrap aluminum. A relatively thick composite particle laminate of such sheets is then produced by pre-heating a plurality of compacted particle sheets and bonding them together by hot rolling in a single pass through a hot rolling mill. One or more cladding layers may be applied to such a laminate composed of AA3105 alloy. It is stated (Example XXX) that AA3104 may be used as a cladding alloy to create a can sheet product of increased brightness and reduced die-pickup tendencies. The resulting composite may be cold rolled to improve strength and to impart the desired gauge. The laminate may also comprise (Example L) AA3004 subsequently clad with an improved commercial can stock (MD-183) and cold-rolled to about 0.015 inch gauge. The resulting laminates were fabricated into cans, but the surface quality of the cans was not good.

There is a need for can body stock that is suitable both for the drawing and ironing steps and the die necking steps so that container body production may proceed more reliably and predictably.

### BRIEF SUMMARY OF THE INVENTION

According to one exemplary embodiment, there is provided a can body stock having opposed first and second surfaces (the first surface being the one intended to contact a drawing die during drawing and ironing, and the second surface being one intended to contact a drawing punch). The can body stock has a core layer, a cladding layer at the first surface of the sheet article, and optionally a cladding layer at the second surface of the sheet article. The cladding layer at the first surface is made of an aluminum alloy selected from aluminum alloys AA3004, AA3104 and modified versions of alloys AA3004 and AA3104 additionally containing 1.0 to 2.0 wt % Fe and optionally up to 1 wt % Si, and the core layer is an aluminum alloy having yield strength less than that of the aluminum alloy of the cladding layer at the first surface.

In exemplary embodiments, the alloy AA3104 or AA3004 makes the can body stock compatible with the requirements of the drawing and ironing procedure, whereas the softer alloy of the core makes the can body stock sheet article more suitable for necking-in steps during die necking operations. Moreover, the softer core may make tools subject to less wear during drawing and ironing and other operations.

By the term “can body stock” we mean a sheet article which, in the exemplary embodiments, is a composite or multi-layer sheet of at least two layers (a core and a cladding) of different aluminum alloys. The can body stock is generally flat or coiled and is preferably sized to enable it to be cut into blanks suitable for the preparation of container bodies intended for holding beverages or liquids of other kinds.

In the normal use of the terms within the industry, the clad (or cladding) layer is usually the term given to that layer which dictates surface characteristics such as corrosion resistance or brightness. The core layer is usually the term given to the layer whose primary purpose is to influence the bulk mechanical properties of the overall sheet product. The clad layer is usually, but may not always be, thinner than the core layer. A composite or multi-layer sheet material may consist only of a core layer and a cladding layer, but sheet materials having three or more layers may be provided. Clearly, in a three or more layer structure, the core layer is generally an internal layer, i.e. the central layer of a three layer structure.

The yield strength (YS) of an alloy (often called “yield stress”) is the stress value (load/area) at which the metal changes from elastic to plastic behavior, i.e. begins to plastically deform or takes on a permanent set. Values of yield strength for various alloys are well known and can be determined empirically by simple known tests. The yield strength of an alloy depends to some extent on the temper of the alloy; however, for non-heat treatable alloys, the core layer and cladding layer(s) will be in the same temper since they will both have been subjected to the same thermo-mechanical treatment (i.e. combination of rolling and thermal treatment). For can body stock produced with conventional thermo-mechanical steps (e.g. cold rolled by about 85% from a soft reroll gauge with some recovery associated with a cold mill exit temperature of about 130 to 150° C.), both the core and the cladding layer(s) will be in the same “H19” temper. Consequently, a comparison of the yield strength values in this temper is appropriate if this is the final temper of the alloys in the can body stock.

For an understanding of the number designation system most commonly used in naming and identifying aluminum and its alloys see “International Alloy Designations and Chemical Composition Limits for Wrought Aluminum and Wrought Aluminum Alloys”, published by The Aluminum Association, revised January 2001 (the disclosure of which is incorporated herein by reference).

In the following, when reference is made to alloys AA3004 and AA3104 being used as a cladding, it should be kept in mind that the modified versions of these alloys (containing 1.0 to 2.0 wt % Fe, and optionally up to 1.0 wt % Si) may be used instead, especially when the can body stock is made from co-cast or sequentially-cast composite or multi-layer ingot, for the reasons explained later in this description.

In exemplary embodiments, the aluminum alloy of the core layer preferably has a content of magnesium of 0.15 wt % or less and a yield strength of less than 40 ksi (when the cladding on the first surface is AA3104) or less than 38 ksi (when the cladding on the first surface is AA3004), and may be made, for example, of an aluminum alloy of specification AA3003 (AA3003H18 has a yield strength of about 27 ksi) or X385. The cladding layer at the first surface preferably has a thickness of at least 2% of a total thickness of the sheet article. A cladding layer may also be provided at the second of the opposed surfaces, the cladding layer on the second opposed surface being AA3104, AA3004 or a different alloy, e.g. alloy AA1100.

Another exemplary embodiment provides a method of preparing a container body comprising the steps of providing a can body stock, cutting the can body stock into blanks, cupping the blanks to form cups, extending the cups by drawing and ironing to form container bodies, trimming the container bodies to form trimmed container bodies, and then shaping the trimmed container bodies by a number of die necking operations, wherein the can body stock is as defined above. Another exemplary embodiment relates to a container body made of a can body stock by the method as defined above.

It is believed that the clad metal sheet of the exemplary embodiments may be effective for container body manufacture for the following reasons. Fracture during neck formation is caused by strain localization often in the form of shear bands. Providing the softer alloy in the core, as in the exemplary embodiments, makes the material less prone to strain localization by shear band formation and thus more readily formable in the neck forming operation.

### BRIEF DESCRIPTION OF THE DRAWINGS

Exemplary embodiments of the present invention are illustrated in the accompanying drawings, in which:

FIG. 1 is a schematic cross-section of a composite can body stock sheet article, shown on a magnified scale, to illustrate one exemplary embodiment of the present invention; and

FIG. 2 is a perspective view of a beverage container body made of a composite can body stock sheet article according to an exemplary embodiment of the present invention.

### DETAILED DESCRIPTION OF THE EXEMPLARY EMBODIMENTS

As noted above, the aluminum alloys conventionally used for can body stock are alloys AA3104 and AA3004 (having yield strength values in conventional can body stock of 40 and 38 ksi, respectively). These alloys are chosen for their compatibility with the drawing and ironing procedure. This procedure involves extending the sides of a short metal cup made from the can body stock by positioning the cup on the end of a punch and pushing the cup through one or more annular dies having internal diameters slightly smaller than the outer diameter of the cup, thereby thinning and extending the sidewalls of the cup along the punch to form an elongated container body. The punches and dies typically produce millions of container bodies in this way before being discarded or retooled.

Without wishing to be bound by any particular theory, it is believed that alloys AA3104 and AA3004 are suitable for the drawing and ironing process because they contain intermetallic particles of a kind that “scrub” the ironing tools (punch and die) to prevent metal build up on the tools over time, and thereby avoid metal tear-offs and metal scoring during the ironing stage. It is the larger intermetallic particles that are effective and metals containing insufficient particles of this kind (or an insufficient density of such particles) allow metal build-up since the tooling is not being scrubbed sufficiently. However, if there are too many such particles, they may cause excessive tool wear because the tooling is being scrubbed too much. Alloys AA3004 and AA3104 have been found to provide a good compromise in this regard. This scrubbing effect is apparent both on the die side and on the punch side of the can body stock, but the effect is more critical on the die side because metal build up creates lumps on the die and the lumps produce lines (referred to as scoring) on the resulting container body. Excessive tool wear, on the other hand, produces a rougher die which gives a duller looking container wall. There is less concern about the appearance of the inside of the container, so metal build up and tool wear is generally less of a concern on the punch side if it does not become excessive. Without the indicated scrubbing action carried out on the drawing and ironing tools, the commercial production of container bodies would not be economic in many or most cases. Alloys AA3004 and AA3104 contain a significant content of Mg (0.8 wt. % or more) that gives the alloys a degree of hardness acceptable for the drawing and ironing steps, but can also produce difficulties during the necking-in steps, particularly when large reductions of container body diameters are attempted. However, the inventors have determined that the ability of these alloys to scrub the ironing tools is just a surface effect, so it is only necessary to provide the AA3004/3104 alloy at the surface of the can body stock that contacts the ironing rings (the surface of the sheet that ultimately forms the exterior of the container body) and possibly also the surface that contacts the ironing punch (the surface ultimately forming the interior). The interior (or core) of the sheet itself may be made of an alloy that is better suited to undergo die necking operations.

It has now been found that properties appropriate for both steps (drawing and ironing, and die necking) can be provided by cladding a softer aluminum alloy (provided as a core layer) with a layer of AA3104 or AA3004 (or their modified versions) on one or both sides (provided as a cladding layer(s)). By the term “softer aluminum alloy” we mean one that has a lower yield strength than alloys AA3104 and AA3004, i.e. generally less than 40 ksi or 38 ksi (depending on which alloy is used for the cladding). Softer alloys are generally those having lower contents of Mg than AA3104 and AA3004 but are also preferably alloys of the AA3XXX series (alloys having Mn as the main alloying element).

The softer alloy used for the core preferably contains 0.15 wt. % Mg or less, and optionally little or no Mg. Suitable alloys include, but are not limited to, alloys AA3003 or X385 (the latter being a proprietary designation). The constituent elements of the various alloys mentioned above are shown in Table 1 below:

TABLE 1

| ALLOY | Si | Fe | Cu | Mn | Mg | Cr | Zn | Ti |
|---|---|---|---|---|---|---|---|---|
| AA3004 | 0-0.3 | 0-0.7 | 0-0.25 | 1.0-1.5 | 0.8-1.3 | — | 0-0.25 | — |
| AA3104 | 0-0.6 | 0-0.8 | 0.05-0.25 | 0.8-1.4 | 0.8-1.3 | — | 0-0.25 | 0-0.10 |
| Typical | | | 0.17 | 0.87 | 1.2 | | | |
| AA3004 | 0-1.0 | 1.0-2.0 | 0-0.25 | 1.0-1.5 | 0.8-1.3 | — | 0-0.25 | — |
| Modified | | | | | | | | |
| AA3104 | 0-1.0 | 1.0-2.0 | 0.05-0.25 | 0.8-1.4 | 0.8-1.3 | — | 0-0.25 | 0-0.10 |
| Modified | | | | | | | | |
| AA3003 | 0-0.6 | 0-0.7 | 0.05-0.20 | 1.0-1.5 | — | — | 0-0.10 | — |
| X385 | 0-0.2 | 0-0.4 | 0-0.4 | 0-1.5 | 0-0.15 | 0-0.1 | — | — |

| | | | | | | | |
|---|---|---|---|---|---|---|---|
| AA1100 | Si + Fe 0-0.95 | 0.05-0.20 | 0-0.05 | — | — | 0-0.10 | — |

The balance of the alloys in Table 1 is aluminum (together with unavoidable impurities).

As noted, the core layer of the can body stock of the exemplary embodiments may be clad with such alloys on one or both sides. If clad on only one side, it should be the side intended to contact the die rather than the punch in a drawing and ironing step (i.e. the side that will ultimately form the exterior surface of the container body). If clad on both sides, the cladding layer on the side intended to contact the punch during a drawing and ironing step (i.e. the interior surface of the eventual container body) may be clad with alloy AA3004 or AA3104, or with different alloy, as explained later below.

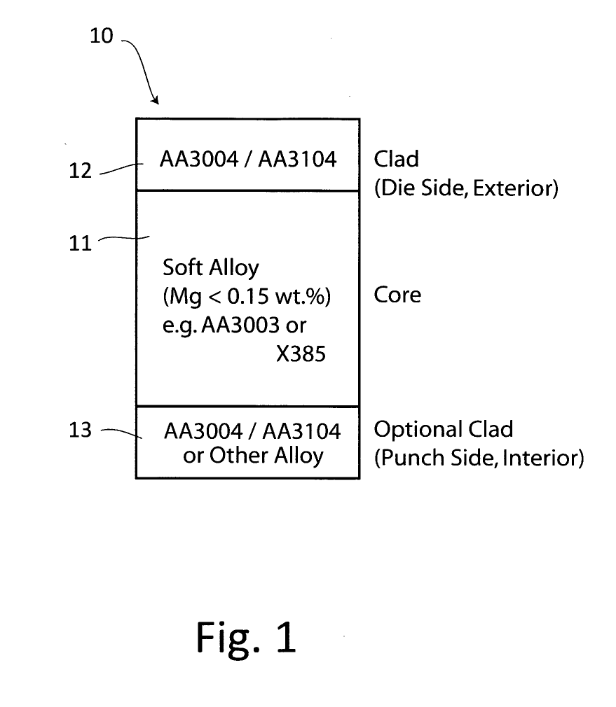

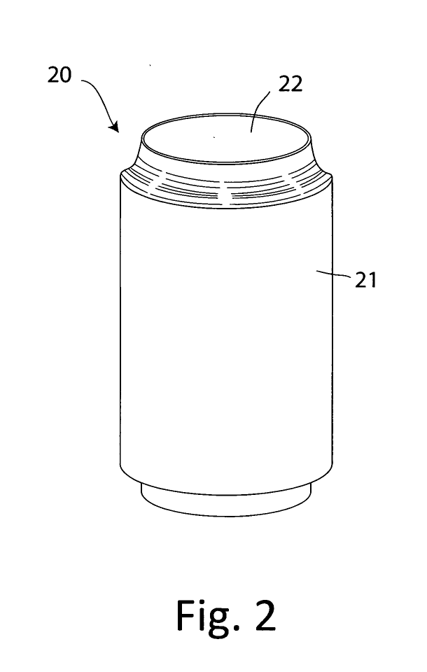

FIG. 1 of the accompanying drawings is a schematic illustration of a clad structure 10 according to one exemplary embodiment. The structure comprises a core layer 11 clad at one surface (the eventual exterior of a container body) with a cladding layer 12. A second cladding layer 13 may be provided at the opposite surface (the eventual interior surface). The material of the core in this embodiment is a soft alloy (preferably of the AA3XXX series) having an Mg content less than 0.15 wt %, e.g. alloy AA3003 or X385. The material of the cladding layers 12 is AA3004 or AA3104. The material of optional cladding layer 13 may be AA3004, AA3104 or a different alloy. FIG. 2 shows a container body 20 made from the can body stock shown in FIG. 1 by a process involving drawing and ironing and then necking operations to form a narrow opening at the open end. The outside 21 of the container 20 is the side that contacted the ironing rings (or die). The inside 22 is the side that contacted the ironing punch.

Clad structures of the kind used in the exemplary embodiments and as illustrated in FIG. 1 may be produced by various methods, e.g. by diffusion bonding (in which slabs, plates or ingots of the different metals are specially treated and contacted to form a metallurgical bond when heated to a high temperature below the melting point) or roll bonding (in which slabs, plates or ingots of the different metals are mechanically attached together by welding or the use of straps, and then rolled to the desired thickness). However, it is most preferable to produce the illustrated structures by hot and cold rolling a composite or multi-layer metal ingot. There are several techniques for producing such ingots, e.g. simultaneously direct chill (DC) co-casting two or more metal layers, sequentially casting one or more layers on a core layer that has already solidified, or sequentially contacting a molten metal with a semi-solid surface of a layer previously cast. Some of these methods involve the use of chilled divider walls to separate the entrance of a chilled casting mold into two or more compartments, and the use of cooling water that is poured onto the surface of the ingot as it emerges from the mold. US patent publication no. 2005/0011630, published on Jan. 20, 2005, in the name of Anderson et al. (the disclosure of which is specifically incorporated herein by this reference) relates to a method involving the use of one or more chilled divider walls in a chilled mold to bring about contact of a molten metal with a semi-solid surface of a layer previously cast (i.e. it involves sequential co-casting onto a semi-solid surface in a chilled wall mold employing a chilled divider wall and cooling water poured onto the emerging ingot). This method in particular advantageously assures that the layers are continuous and dense (i.e. solid metal throughout without voids or structures made of discrete interconnected particles, e.g. as produced from rolled solid ingot, plate or slab) and that a good metallurgical bond is achieved between the various layers. The resulting ingot may be subjected to heat homogenization, and then hot and cold rolling of the ingot to produce a sheet article of desired final gauge suitable for can body stock, can end stock or tab stock. During a long homogenization period, magnesium from one layer may diffuse into another layer and give rise to a diffuse concentration gradient rather than an abrupt interface. This may be advantageous to avoid sharp stress ambiguity. It is also to be noted that alloys containing Mg are prone to oxidation so that it is difficult to combine such alloys with layers of other alloys by more conventional means. Consequently, the procedure of US patent publication no. 2005/0011630 is preferred for this reason as well.

It has further been noticed that, when casting processes involving the use of chilled molds having chilled divider walls and poured cooling water (e.g. the process of US patent publication no. 2005/0011630 in particular) are used to produce a composite (multi-layer) ingot having a cladding of alloy AA3004/3104 on one or both main surfaces, the cladding may have a lower density of intermetallic particles than when a cladding of alloy AA3004/3104 is produced in other ways (e.g. as produced from monolithic slabs joined by roll bonding and the like). This may be because, when a composite ingot with a relatively thin cladding layer is cast by such a process, the cladding layer is rapidly cooled throughout by the chilled mold walls, the chilled divider walls and the cooling water applied to the surface of the ingot, so large intermetallic particles have less opportunity to form and grow in size than when casting is carried out in other ways. Since the presence of large intermetallic particles in the cladding layer(s) in high density is desired for the reasons given herein, it is desirable to promote their formation when using such casting techniques and equipment by adding more iron and possibly more silicon to the known AA3104/3004 formulation. Therefore, for can body stock formed by this route, the cladding alloy may have the formulation or specification of AA3104/3004 modified to include Fe in an amount of 1 to 2 wt %, and Si in an amount up to 1 wt % (i.e. 0 to 1 wt %). Such alloys and their formulations are shown as alloy “AA3004 Modified” and alloy “AA3104 Modified” in Table 1 above.

If desired, the sheet of can body stock may be made to have the same gauge as conventional can body stock, e.g. that used to produce beverage cans or metal bottles. Although a softer alloy is used for the core, the column strength of the resulting containers is related to the onset of yielding during bending, and this is dependent more on the strength of the outer surface than the strength of the core. However, a small increase in gauge may be provided, if desired.

The cladding layer of AA3004/3104 alloy (on the die side and optionally on the punch side) may be made quite thin, e.g. 100 μm or less. As noted above, it is believed to be the larger intermetallic particles of these alloys that are responsible for the scrubbing effect during drawing and ironing, i.e. particles in the size range of 5-10 μm (frequently 3 to 5 μm, but possibly as large as 25 μm). The size of these particles sets the lower limit for the thickness of the cladding layer after ironing (the thickness should preferably be no less than the size of the largest particles). Based on this, the minimum thickness of the cladding (after ironing) may be 5-20 μm. The upper part of this range goes beyond the size range of the particles for appearance reasons. That is to say, if the cladding thickness is too close to the particle size, the cladding layer may not remain fully intact after ironing, i.e. a void may be created due to a lack of the bulk phase of the metal to cover and/or fill in behind a particle that becomes exposed as the side wall thins.

As for the maximum clad thickness values, there is no upper limit, but the maximum values must be compatible with achieving the desired necking properties of the sheet. It is therefore desirable to make the thickness of the cladding close to the minimum acceptable values mentioned above. In practice, a thickness range of 5 to 100 μm is preferred. Table 2 shows examples of suitable cladding layer thicknesses before and after ironing:

TABLE 2

| Target Ranges | AS ROLLED¹ | AS IRONED² |
|---|---|---|
| Working | 2-30% | 0.0002-0.0020 (5-51 μm) |
| Preferred | 5-15% | 0.0004-0.0010 (10-25 μm) |
| Most Preferred | 10-12.5% | 0.0008-0.0009 (20-23 μm) |

¹% of total sheet thickness (as rolled gauge = 0.008-0.030 inch or 0.2-0.8 mm)
²based on “as-ironed” gauge of mid-sidewall of 0.003-0.007 inch or 0.076-0.178 mm

As noted above, the lowest limit of the as-ironed clad thickness of 5 μm or 0.0002 inch is set by the lower limit on the size of the intermetallic particles. The most preferred lower limit of 0.0008 inch or 20 μm is twice the diameter of the largest intermetallic particles to help to ensure the maintenance of a continuous film of intact clad metal after ironing. The most preferred upper limit of 12.5% of the sheet thickness (pre-ironing) provides a clad sheet with essentially the same necking-in characteristics as a single layer of the core alloy.

As an example, the thickness of can body stock for a 24 ounce can may be 363 μm. If the cladding is at the lower limit of 2% of the thickness, it should have a thickness of 7.26 μm. If it is at the upper limit of 25%, it should have a thickness of 90.75 μm. A preferred range may be 7% for a thickness of 25.41 μm.

As mentioned, the side of the sheet intended to contact the ironing die is provided with a cladding layer of alloy AA3004/AA3104 and the provision of a cladding layer on the opposite side (ironing punch side) is optional. Thus, the opposite side of the core may remain unclad or, alternatively, may be clad with a cladding layer of AA3004/3104 or yet another metal having desirable properties. If AA3004/3104 is used as the cladding layer on the punch side, the comments above regarding the thickness of the cladding layer on the die side also apply to the cladding on the punch side. The punch side is the side of the core that, in the finished container, will be exposed to the container contents which, for example in the case of many soft drinks and sports drinks, may be quite acidic or corrosive. If AA3004/3104 is not needed to prevent metal build-up on the punch side, a cladding layer that resists corrosion in such conditions, or provides some other benefit, such as metal brightness, may be provided instead. The particular alloy and thickness chosen for this layer will depend on the desired characteristics.

A particularly preferred embodiment has a cladding layer 13 made of an alloy that is easy to clean. Container bodies are often washed with acid cleaning solutions to remove oils and other contaminants and it is desirable to minimize the amount of the solution employed. Somewhat counter-intuitively, surfaces that are soft and crack easily under hydrodynamic pressure (during rolling using viscous rolling lubricants) are easier to clean than smooth surfaces. This is because there is more surface area exposed in the former case and the acid more easily dissolves impurities that are in or just below the surface. In the case of a smooth surface, it may be necessary to etch away an entire layer of metal before the desired cleaning effect is achieved. Therefore, layer 13 may be made of a metal having these properties, e.g. AA1100.

In some cases, the can body stock may have more than just two or three layers. One or more internal layers or so-called interlayers may also be provided between the core layer and a cladding layer. One reason for this would be, for example, to prevent alloying elements from migrating from one layer to another. For example, as mentioned above, a fast-diffusing element such as Mg may diffuse into an adjacent layer during homogenization. While this may be regarded as desirable in many situations, there may be cases where it is not. To avoid such diffusion, an intervening layer (interlayer) of a metal that slows or prevents such migration may be provided. Such a layer would preferably only be as thick as required to prevent significant diffusion so as to have little impact on the other properties of the overall alloy sheet article.

The can body stock according to the exemplary embodiments may be coated after container body formation with paint layers or protective layers (on the exterior) and coating layers of polymers or the like (on the interior) in conventional ways.

Can body stock according to the exemplary embodiments may be used in the same way as conventional can body stock for the production of container bodies. Of course, if the gauge of the stock differs from the conventional gauge, standard adjustments of the tools would have to be made in order to accommodate the gauge difference. It is also possible to produce container bodies of all conventional sizes and shapes.

What we claim is:

1. Can body stock having opposed first and second surfaces, said can body stock comprising a core layer, a cladding layer at said first surface of the sheet article, and optionally a cladding layer at said second surface of the sheet article, wherein said cladding layer at said first surface is made of an aluminum alloy selected from the group consisting of alloys AA3004, AA3104 and modified versions of alloys AA3004 and AA3104 additionally containing 1.0 to 2.0 wt % Fe and optionally up to 1 wt % Si, and the core layer is an aluminum alloy having yield strength less than that of the aluminum alloy of the cladding layer at said first surface.

2. The can body stock of claim 1, wherein said aluminum alloy of said core layer has a content of magnesium of 0.15 wt % or less.

3. The can body stock of claim 1, wherein said aluminum alloy of said core layer has a yield strength of less than 40 ksi when said alloy of the cladding layer is AA3104, and less than 38 ksi when said alloy of the cladding layer is AA3004.

4. The can body stock of claim 1, wherein the core layer is made of an aluminum alloy AA3003.

5. The can body stock of claim 1, wherein the core layer is made of aluminum alloy X385.

6. The can body stock of claim 1, wherein a cladding layer is provided at said second of said opposed surfaces, said cladding layer on said second opposed surface being an aluminum alloy selected from the group consisting of alloys AA3104, AA3004 and modified versions of alloys AA3004 and AA3104 additionally containing 1.0 to 2.0 wt % Fe and optionally up to 1 wt % Si.

7. The can body stock of claim 1, wherein a cladding layer is provided at said second of said opposed surfaces, said cladding layer at said second opposed surface being an aluminum alloy different from alloys AA3104, AA3004 and said modified versions thereof.

8. The can body stock of claim 7, wherein said different aluminum alloy is alloy AA1100.

9. The can body stock of claim 1, wherein said cladding layer at said first surface has a thickness of at least 2% of a total thickness of said sheet article.

10. The can body stock of claim 1, wherein said cladding layer at said first surface has a thickness of 2 to 25% of a total thickness of said sheet article.

11. The can body stock of claim 1 having been produced by hot and cold rolling a direct chill co-cast or sequentially-cast composite ingot, wherein said cladding layer at said first surface is made of an aluminum alloy selected from the group consisting of alloys of specification AA3104 and AA3004 additionally containing 1.0 to 2.0 wt % Fe and optionally up to 1 wt % Si.

12. The sheet of claim 11 having been produced by hot and cold rolling of a co-cast or sequentially-cast ingot formed in a chilled mold having at least one chilled divider wall employing cooling water poured onto said ingot as it emerges from the mold.

13. The sheet of claim 12, wherein said sheet is formed from a sequentially-cast ingot formed by a process as disclosed in US patent application publication no. 2005/0011630.

14. A method of preparing a container body comprising the steps of providing a can body stock, cutting the can body stock into blanks, cupping the blanks to form cups, extending the cups by drawing and ironing to form container bodies, trimming the container bodies to form trimmed container bodies, and then shaping the trimmed container bodies by a number of die necking operations, wherein said can body stock is as defined in claim 1.

15. A container body made by the method of claim 14, said container body having an exterior surface formed by said first cladding layer of said can body stock containing large intermetallic particles, and an interior surface formed by said core layer or said second cladding layer of said can body stock.

16. The container body of claim 15, wherein said large intermetallic particles have a size in the range of 5 to 10 μm.

17. The container body of claim 16, wherein a minimum of said thickness of said cladding layer on said exterior surface is in a range of 5-20 μm.

18. The container body of claim 16, wherein said thickness of said cladding layer on said exterior surface is within the range of 5 to 100 μm.
